(19) United States
(12) Patent Application Publication
(10) Pub. No.: US 2026/0288595 A1
(43) Pub. Date: Sep. 24, 2026

(54) REPLICATION RECOVERY TECHNIQUES FOR SIDELINED PARTITIONS

(71) Applicant: Oracle International Corporation, Redwood Shores, CA (US)

(72) Inventors: Kevin Zhang, Pittsburgh, PA (US); Arsalan Ahmad, Redmond, WA (US); Anthony Furious Long, Edmonds, WA (US); Krishna Sai Veera Reddy, Seattle, WA (US)

(73) Assignee: Oracle International Corporation, Redwood Shores, CA (US)

(21) Appl. No.: 19/087,138

(22) Filed: Mar. 21, 2025

(51) Int. Cl. G06F 11/14

(52) U.S. Cl. CPC G06F 11/1451; G06F 11/1469; G06F 11/1492

(57) ABSTRACT

The disclosed systems, methods, and computer readable media relate to sidelining a data stream partition (e.g., halting replication of the partition) and resuming replication for a sidelined partition after an a poison pill event that triggered the sidelining is resolved. While the partition is sidelined, stream event processing for the partition may be restricted/blocked/halted, while stream event processing for active partitions of the data stream continue. After the error is resolved, a process for resynchronizing the partition based on the stream events that were received from the point at which the error was originally detected may be performed. Some stream events for the partition may be obtained from a snapshot generated by a snapshot service, while other stream events during the resynchronization may be obtained from a demuxer. Once the partition is resynchronized, the partition may be un-sidelined such that subsequent stream events for the partition may be processed unrestricted.

### BACKGROUND

It is common practice within cloud computing system to replicate data from a cloud computing service's control plane (CP) to its corresponding data plane (DP). The control plane data may be streamed to various data plane clients. The data plane client may subscribe to any suitable number of streams, each stream being associated with any suitable number of partitions (e.g., used to identify subgroupings of stream data). When a data plane client cannot process a stream event, replication for all subscribed partitions is halted (referred to as “sidelining”). Extrapolating this issue to a fleet of data plane clients, this could mean that every partition of a stream may be sidelined, causing replication of the stream to halt. Conventional replication platforms utilize tedious and error-prone manual efforts to bring a sidelined partition back to a state in which replication may resume (referred to herein as “un-sidelining”). In some cases, these systems require each stream event in the replication channel to be corrected manually. Conventional sideline recovery techniques create unnecessary delay with respect to replication of one or more sidelined partitions of a stream.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

At least one embodiment includes a method. The method may comprise receiving, by a client device from a demuxer of a replication streaming system, a first stream event corresponding to a data stream that is associated with a plurality of partitions. In some embodiments, the first stream event identifies a partition of the plurality of partitions and a streaming cursor. The client device may track unrestricted replication for the partition using the streaming cursor. The method may comprise restricting, by the client device, replication for the partition based on generating a sideline cursor from the streaming cursor. In some embodiments, restriction the replication for the partition may be in response to detecting an error corresponding to the first stream event. The method may comprise executing, by the client device using the sideline cursor, a bootstrap process during which a second stream event for the partition is obtained from a snapshot of the data stream. The method may comprise executing, by the client device using the sideline cursor, a catch up process during which a third stream event occurring after the second stream event in the data stream is obtained. The method may comprise resuming, by the client device, the unrestricted replication for the partition based at least in part on concluding the catch up process.

In some embodiments, the first stream event and the third stream event are obtained from the demuxer, and the second stream event is obtained from a data snapshot service instance of the replication streaming system.

In some embodiments, the data snapshot service instance generates the snapshot of the data stream, wherein the second stream event is obtained from the snapshot of the data stream and transmitted based at least in part on receiving a bootstrap request message. The bootstrap request message may be transmitted by the client device as part of the bootstrap process.

In some embodiments, the catch up process is executed based at least in part on determining that the bootstrap process has concluded.

In some embodiments, the client device stores respective values of the streaming cursor based at least in part on successfully processing respective stream events received from the demuxer.

In some embodiments, the demuxer receives stream events comprising the stream event from a streaming platform and distributes the stream events according to the plurality of partitions. The streaming platform may distribute the stream events according to a second plurality of partitions that differ from the plurality of partitions used by the demuxer.

In some embodiments, determining that the catch up process has concluded comprises receiving a catch up message that indicates the catch up process has concluded.

In some embodiments, a client device is disclosed. The client device may comprise one or more processors and one or more memories storing computer-executable instructions that, when executed by the one or more processors, causes the one or more processors to perform any of the methods disclosed herein. In one example method, the one or more processors incrementally process stream events of a data stream that is associated with a plurality of partitions. In some embodiments, a most-recently received stream event identifies a partition of the plurality of partitions and a first cursor that represents a position in the data stream corresponding to the most-recently received stream event. In one example method, the one or more processors restrict replication at the partition. The replication at the partition may be restricted in response to detecting an error corresponding to the most-recently received stream event. In one example method, the one or more processors obtain, using a second cursor that indicates the position in the data stream corresponding to the most-recently received stream event, a first set of stream events for the partition. In some embodiments, the first set of stream events may be obtained from a snapshot of the data stream. In one example method, the one or more processors obtain a second set of stream events for the partition. The second set of stream events may occur after the first set of stream events in the data stream. In one example method, the one or more processors resume unrestricted replication of the partition based at least in part on obtaining the first set of stream events and the second set of stream events.

In some embodiments, executing the computer-executable instructions further cause the one or more processors to process a subsequent stream event corresponding to a second partition of the plurality of partitions. The subsequent stream event may correspond to the second partition being processed while the replication for the partition is being restricted.

In some embodiments, executing the computer-executable instructions further cause the one or more processors to 1) incrementally process respective stream events of the first set of stream events and the second set of stream events and 2) update the second cursor as the respective stream events of the first set of stream events and the second set of stream events are incrementally processed. In some embodiments, the second cursor indicates progress of processing the first set of stream events and the second set of stream events.

In some embodiments, executing the computer-executable instructions that obtain the first set of stream events for the partition, further causes the one or more processors to transmit, to a data snapshot service, a bootstrap request comprising a first value of the second cursor.

In some embodiments, executing the computer-executable instructions that obtain the second set of stream events for the partition, further causes the one or more processors to transmit, to a demuxer, a catch up request comprising a second value of the second cursor.

In some embodiments, the second value of the second cursor is identified based at least in part incrementally updating the second cursor as the first set of stream events are processed.

The second value of the second cursor may correspond to a corresponding position within the data stream that is associated with a last stream event processed of the first set of stream events.

In some embodiments, executing the computer-executable instructions further causes the one or more processors to receive a catch up end message that indicates a current value maintained by the demuxer for the first cursor. In some embodiments, the unrestricted replication of the partition is resumed using the current value for the first cursor.

A non-transitory computer-readable medium is disclosed. The non-transitory computer-readable medium may comprise one or more memories storing computer-executable instructions that, when executed by one or more processors of a client device, cause the one or more processors to perform any of the methods disclosed herein. In one example method, the one or more processors incrementally process stream events of a data stream that is associated with a plurality of partitions. In one example method, the one or more processors track processing of the stream events based at least in part on maintaining a first set of cursors that individually indicate a last stream event that was successfully processed for a respective partition. In one example method, the one or more processors restrict stream event processing for a second partition of the plurality of partitions based at least in part on detecting an error associated with a stream event associated with the second partition. In some embodiments, the stream event processing for the second partition is restricted while continuing to process stream events for the data stream that correspond to at least one partition of the plurality of partitions. In one example method, the one or more processors obtain a set of stream events for the second partition, the set of stream events occurring in the data stream after the stream event associated with the error. In some embodiments, the set of stream events is obtained responsive to determining that the stream event processing for the second partition is to resume. In one example method, the one or more processors track, using a second cursor that is separate from the first set of cursors, processing of the set of stream events for the second partition. In one example method, the one or more processors resume unrestricted replication of the partition based at least in part on tracking the processing of the set of stream events for the second partition using the second cursor.

In some embodiments, executing the computer-executable instructions that resume the unrestricted replication cause the one or more processors to receive, from a demuxer, a message that indicates that replication of the second partition is caught up to a current position of the data stream. In some embodiments, the unrestricted replication of the second partition is resumed based at least in part on deleting the second cursor.

In some embodiments, the set of stream events comprises a first stream event obtained from a snapshot generated by a data snapshot service and a second stream event obtained from a demuxer.

In some embodiments, the first stream event is obtained from the snapshot during execution of a bootstrap process. In some embodiments, the second stream event is obtained during execution of a catch up process. In some embodiments, the second cursor is used to track progress of the bootstrap process and the catch up process.

In some embodiments, at least one cursor of the first set of cursors is updated based at least in part on processing a second data stream corresponding to a third partition of the plurality of partitions. The third partition may be different from the second partition. The at least one cursor may indicate a subsequent position in the data stream that occurs after a position associated with the stream event that is associated with the second partition and for which the error was detected.

In some embodiments, the first set of cursors is updated based at least in part on stream event processing of unrestricted partitions of the plurality of partitions.

At least one embodiment is directed to a cloud-computing system (“the system”). The system may comprise one or more processors and one or more memories storing computer-executable instructions that, when executed by the one or more processors, cause the one or more processors to perform any of the methods disclosed herein.

In some embodiments, the one or more processors discussed in connection with the methods, devices, systems, and computer-readable medium herein may be one or more processors associated with a streaming service (e.g., a streaming service that is configured to replicate control plane data to data plane components corresponding to a cloud service).

### BRIEF DESCRIPTION OF THE DRAWINGS

FIG. 1 is a block diagram depicting a cloud-computing environment including a control plane and a data plane, according to at least one embodiment.

FIG. 2 is a block diagram depicting a data stream (e.g., data stream 202), according to at least one embodiment.

FIG. 3 is a block diagram depicting an example Data Snapshot Service (DSS) instance, according to at least one embodiment.

FIG. 4 is a flow depicting operations for sidelining and automatically catching up a previously sidelined partition, according to at least one embodiment.

FIG. 5 is a block diagram depicting example metadata states corresponding to the flow of FIG. 4, according to at least one embodiment.

FIG. 6 is a block diagram depicting an example method for sidelining a partition due to detecting an error and automatically resuming replication for the partition, according to at least one embodiment.

FIG. 7 is a block diagram illustrating one pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A replication platform is disclosed which may be used to distribute (e.g., stream) control plane data of a service to data plane clients (e.g., client instances) of a cloud-computing environment. A common problem in replication platforms is the risk of replication disruption due to receiving a stream event that cannot be processed. Conventionally, when a client instance receives a stream event it cannot process (referred to herein as “a poison pill” or a “poison pill event”), replication for all partitions on the host halts. Extrapolated to a fleet, this could mean replication halts for an entire data stream. Conventional approaches of remediating a poison-pill-affected partition often involving tedious and error-prone manual efforts, which negatively affects overall data plane capacity. The disclosed techniques allow poison-pill-affected partitions to fall behind during remediation, while replication safely continues for unaffected partitions. This presents a major replication availability improvement over conventional replication systems, limiting event processing error impact to a smaller blast radius.

A client instance may be configured to subscribe to stream events corresponding to any suitable number of partitions. These stream events may be distributed by a streaming service. In response to detecting a poison pill event corresponding to a partition, the partition may be sidelined (e.g., transitioned to a mode in which replication at the partition is restricted/blocked).

In order to avoid halting replication for all subscribed partitions as is the case in conventional systems and methods, replication is halted only the partition for which the poison pill event is detected. While sidelined, the client instance may be configured to ignore subsequent stream events provided by the streaming service for the sidelined partition. The client instance may continue to process stream events from the streaming service that corresponding to any suitable active (e.g., not sidelined) partition(s). A client instance may manage two sets of cursors (e.g., a stream cursor and a sideline cursor). One set of cursors may maintain respective positions in the data stream for each partition (e.g., identifying the last stream event of a partition that was committed/successfully processed by the client instance). Another set of cursors may maintain positions within a respective sidelined partition (e.g., a poison-pill affected partition for which replication is currently restricted/blocked). The client device(s) may maintain a sideline cursor that maintains the position within the data stream that corresponds to the stream event that caused the processing error.

When the poison pill has been remediated, the disclosed techniques may include automatically catching the affected partition up to a current position in the data stream. An integrated snapshot service (referred to herein as “a data snapshot service”) may be utilized to provide automatic catchup functionality. At any suitable time after the poison pill has been remediated, the client instance may issue a bootstrap request to the data snapshot service using the sideline cursor corresponding to the partition. In response, the data snapshot service may provide stream events from a snapshot, starting at a position corresponding to the sideline cursor (e.g., a position in the data stream corresponding to the poison pill). When stream events of the snapshot are exhausted, the client instance may resume processing stream events from the streaming service.

### Certain Definitions

The following definitions are provided for clarity.

A “distributed streaming platform” (or “streaming platform,” for brevity) refers to an durable streaming message platform with which any suitable data (e.g., control plane data associated with a service) may be replicated to data plane components (e.g., client instances of a data plane) using one or more data streams. An example of a streaming platform may include Apache Kafka, although others are contemplated. A streaming platform may implement a publisher-subscriber design in which a component (e.g., a “publisher”) sends messages (e.g., “stream events”) to multiple interested components (e.g., “subscribers”), allowing for asynchronous communication and decoupling between senders and receivers.

A “demultiplexer” or “demuxer” refers to component of a cloud-provider replication service (referred to herein as “replication service”) that is configured to obtain stream events from a streaming platform and provide the stream events to one or more subscribed components (e.g., client instances, Data Snapshot Service instances, etc.). In some embodiments, the streaming service may be configured to receive stream events of subscribed streaming platform partitions (e.g., partitions utilized by the distributed streaming platform) and distribute those stream events according to a set of stream partitions that may differ from the streaming platform partitions. A demuxer may provide server-side filtering capabilities based on partitions and labels within a data stream that differs from functionality provided by a distributed streaming platform.

A “data snapshot service” (DSS) (also referred to herein as a “snapshot service,” for brevity) refers to a component of a cloud-provider replication service that is configured to generate and maintain one or more snapshots of a data stream and/or partition. In some embodiments, a DSS instance may be configured to provide stream events of a snapshot to a client instance, by request. A DSS instance may be a subscriber of stream events provided by a demuxer.

A “data stream” refers to a continuous flow of data that is published by a streaming platform and consumed by subscribers of the data stream. A data stream may be treated as a sequence of stream events that can be processed in real-time by data plane components that are interested (e.g., subscribed) to the data stream.

A “streaming platform partition” refers to a logical subgroup of messages of a data stream. A distributed streaming platforms may utilize any suitable number of streaming platform partitions. A streaming platform partition may include any suitable number of streaming partitions. In some embodiments, a streaming platform partition may correspond to a bucket or database table. The order of stream events (e.g., messages) of a streaming platform partition may be guaranteed.

A “stream partition” refers to a logical subgroup of stream events of a streaming platform partition. In some embodiments, a streaming service may utilize any suitable number of stream partitions. In some embodiments, a stream partition may correspond to column of a table (e.g., a table corresponding to a streaming platform partition). The order of stream events (e.g., messages) of a stream partition may be guaranteed. Stream partitions may be used to specify a replication partitioning scheme for a client instance's on-host key value store. Unless otherwise specified, the term “partition,” as used herein, is intended to refer to a stream partition.

A “client instance” refers to a cloud-computing virtual machine instance that is configured to receive stream events and update a local key-value store according to those updates. The key-value store (e.g., a Berkeley database, rocksDB, etc.) may be used to as persistent storage on a client instance and may be configured to store replicated data and client metadata.

A “stream cursor” refers to a position marker corresponding to a streaming platform partition. A stream cursor may be used to identify the last stream event that was committed to a client instance's local key-value store. As another example, a stream cursor may be used to indicate a position within a data stream to which a request for stream events relates. In some embodiments, a stream cursor may include multiple fields such as a streaming platform partition identifier, an offset value, a timestamp that is associated with creation of a stream event, or the like.

A “sideline cursor” refers to a position marker corresponding to a sidelined partition (e.g., a streaming platform partitioned for which replication has been halted or is currently restricted due to a poison pill). In some embodiments, a sideline cursor may be a different type of cursor than the stream cursor.

A “poison pill” refers to a stream event that could not be processed by a recipient client device.

A “log sequence number” (LSN) refers to a unique identifier for a stream event.

“Sidelining” refers to a process in which a sub-set of data (partition) in the full stream is ignored by the client for consumption till the poison pill event is fixed.

A “sidelined partition” refers to a partition that has been transitioned to a mode in which replication is restricted/blocked. While a partition is sidelined, a client may ignore subsequent stream events.

An “active partition” refers to a partition for which replication is not currently restricted/blocked.

A “subscription target” refers to data that specifies a subscription for a client instance.

In some embodiments, a subscription target may include a partition identifier for a streaming platform partition and/or a stream partition.

### Example Replication System

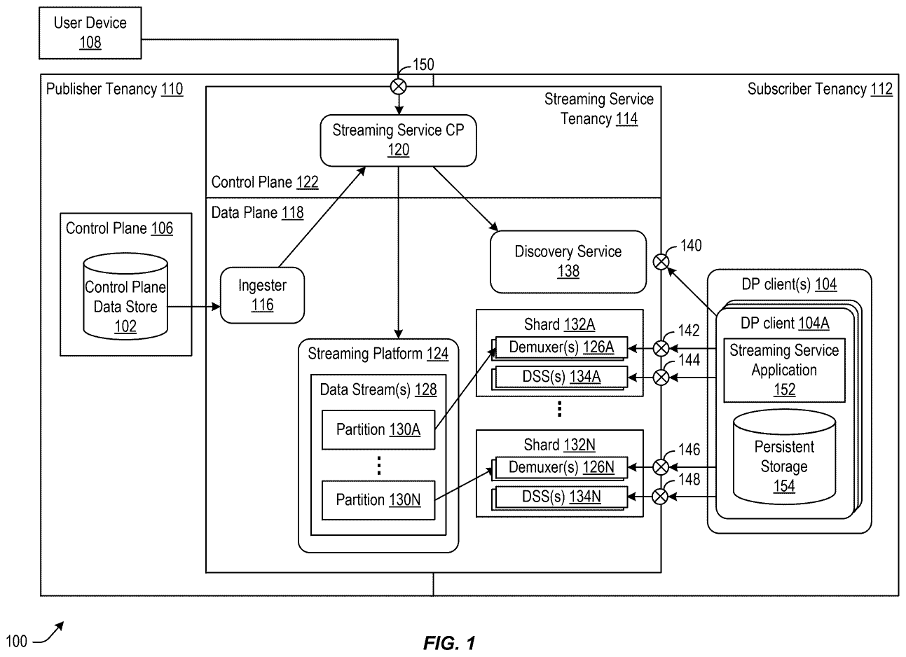

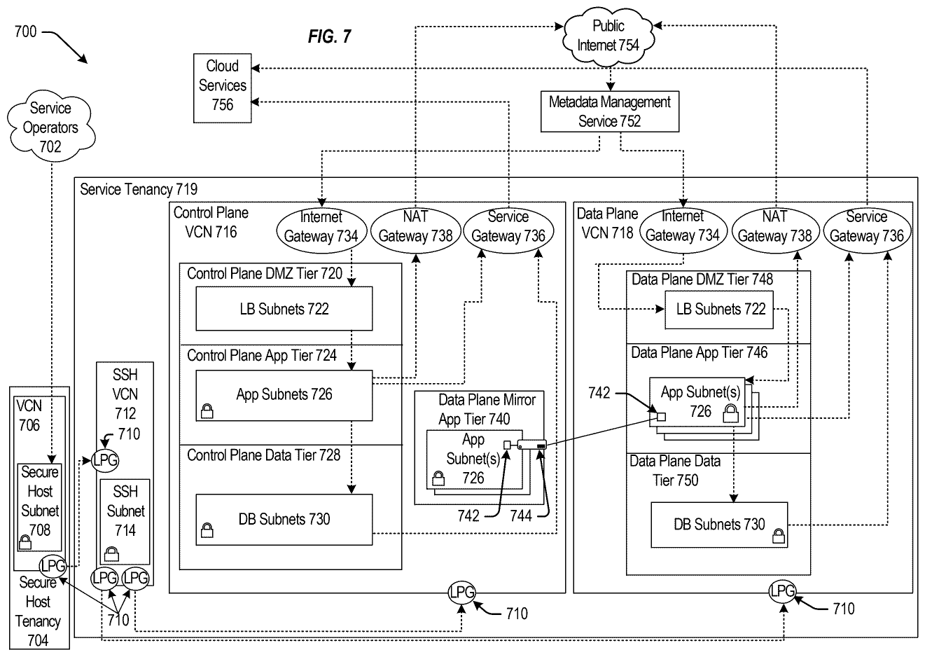

FIG. 1 is a block diagram depicting an example cloud-computing environment (e.g., cloud-computing environment 100), according to at least one embodiment. The cloud-computing environment 100 may depict an environment for distributing control plane data (e.g., of control plane data store 102) to one or more data plane (DP) clients (e.g., DP client(s) 104). In some embodiments, control plane data store 102 may include any suitable data corresponding to control plane 106 (e.g., a control plane corresponding to a cloud service such as one of cloud services 756 of FIG. 7). In some embodiments, DP client(s) 104 may include one or more data plane components (e.g., virtual machine instances, bare metal instances, containers, etc.) corresponding to a cloud service.

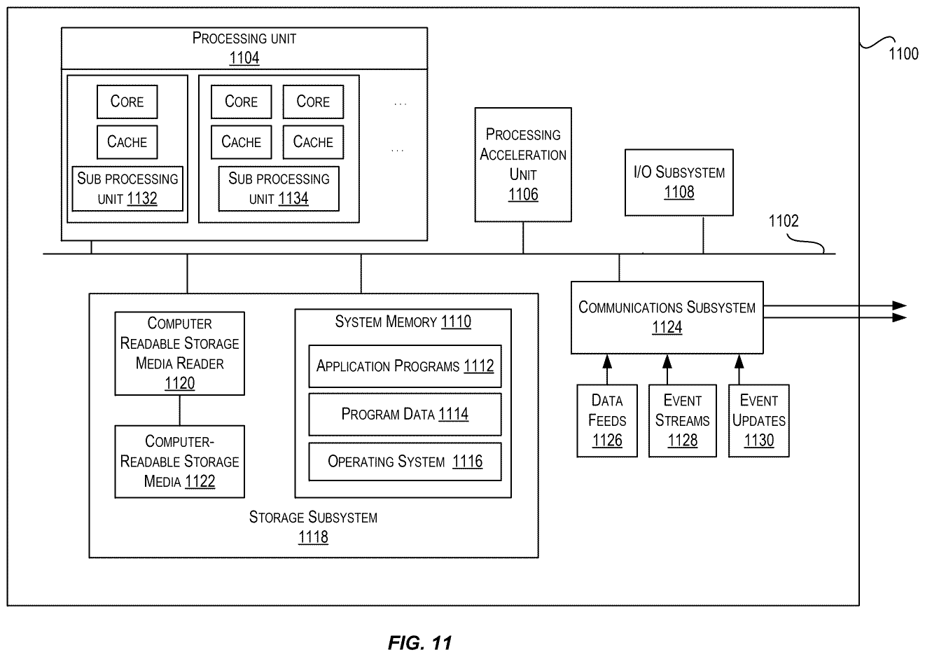

The control plane 106 may be responsible for receiving (e.g., via one or more user interfaces) control plane data updates. A control plane data update may be received by a control plane application programming interface (not depicted). In some embodiments, the control plane data update may be initiated by user via user device 108 (e.g., an example of computer system 1100 of FIG. 11) that is configured to interface with cloud-computing environment 100. Any suitable control plane data updates may be stored in control plane (CP) data store 102.

In some embodiments, cloud-computing environment 100 may be implemented as with a publisher-subscriber design pattern. A publisher-subscriber design pattern refers to a messaging pattern where a component (e.g., a “publisher”) sends messages (e.g., events) to one or more interested components (e.g., “subscribers”), allowing for asynchronous communication and decoupling between senders and receivers. In some embodiments, CP data store 102 may be associated with a publisher corresponding to publisher tenancy 110. DP client(s) 104 may be associated with corresponding to subscriber tenancy 112. In some embodiments, the publisher and subscriber may be associated with control plane and data plane components of the same cloud service. A number of components of a streaming service may be provided within streaming service tenancy 114.

In some embodiments, CP data store 102 may not provide read scalability that is sufficient to serve a large number of data plane clients (e.g., DP client(s) 104). DP client(s) 104 may often number anywhere between hundreds to hundreds of thousands data plane clients. A streaming service (an example of one of cloud services 756 of FIG. 7) may be utilized to stream data from the control plane data store 102 to DP client(s) 104.

Ingester 116 (e.g., a component of the streaming service, a component of data plane 118) may be configured to poll CP data store 102 and/or read data from a commit log of a data store (e.g., a data store storing control plane data) at any suitable time and to provide the obtained control plane data updates to a control plane component of the streaming service (e.g., streaming service control plane (CP) 120 of control plane 122). Streaming service CP 120 may be configured to provide the control plane data updates to streaming platform 124.

Streaming platform 124 may be an example of a durable streaming message platform with which any suitable data may be distributed to one or more subscribers (e.g., Demuxer(s) 126A-N, collectively referred to as “demuxer(s) 126) using one or more data streams (e.g., data stream(s) 128). In some embodiments, data stream(s) 128 may correspond any suitable set of related data. Each data stream may include any suitable number of streaming platform partitions (e.g., partition 130A-N, collectively referred to as “partitions 130”). Each of the demuxer(s) 126 may subscribe to any suitable data stream and/or streaming platform partition to receive stream events corresponding to the data stream/streaming platform partition. Demuxer(s) 126 may distribute and/or demux received stream events based on stream partition and/or label to one or more subscribed DP clients (e.g., any suitable combination of DP client(s) 104). In some embodiments, demuxer(s) 126 may distribute data stream events corresponding to a partition one or more stream partitions that represent sub-sets of related data stream events of the data stream.

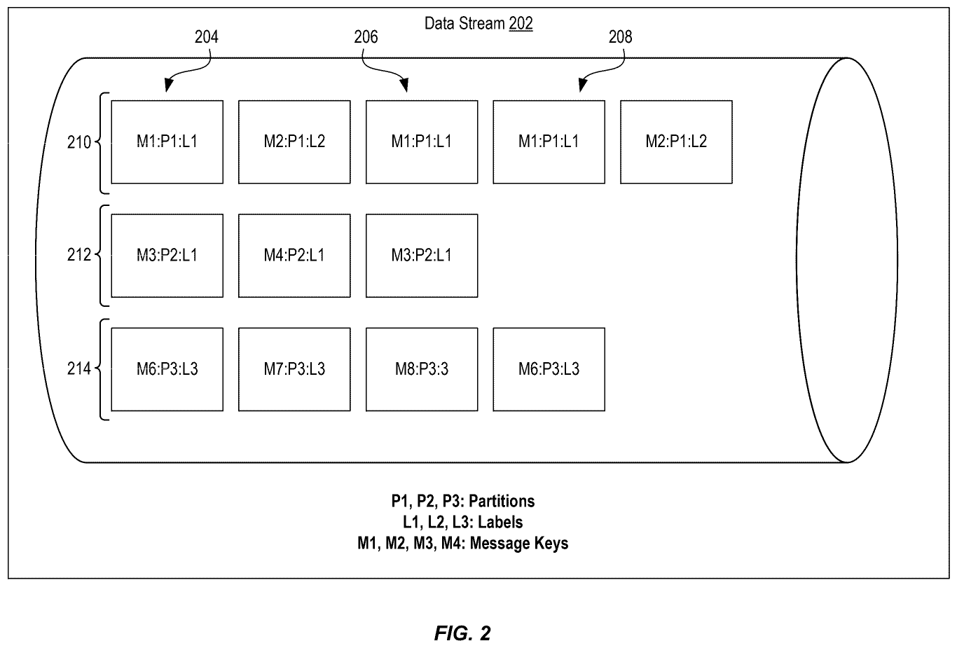

FIG. 2 is a block diagram depicting a data stream (e.g., data stream 202), according to at least one embodiment. In some embodiment, each stream event (e.g., stream event 204) of a stream may include any suitable combination of a partition identifier, a message identifier, one or more labels, a log sequence number (LSN) corresponding to a sequence number assigned by the streaming platform 124, and a data payload.

A message identifier may be used to identify a resource (e.g., a row of a table). In some embodiments, the message identifier may be a hash key of a bucket (e.g., an identifier of a bucket/column of control plane (CP) data store 102 of FIG. 1). In some embodiments, if the data obtained from CP data store 102 is missing a message identifier, the ingester 116 of FIG. 1 may compute (e.g., using a hashing algorithm and a bucket identifier as input) the hash key of the bucket and uses the computed hash key to calculate the message identifier. For example, for a hash key comprising multiple columns (e.g., {column1, column2, column3}) the message identifier may be calculated as “<column1Value>:<column2Value>:<column3Value>.”

In some embodiment, a partition identifier may identify a stream partition (e.g., a sub-partition of the partition 130A of FIG. 1). Stream events corresponding to a stream partition may be considered to be related and may be replicated with ordering guarantees. Stream events in different partitions of the same data stream, may be considered unrelated and may have no ordering guarantees between them.

In some embodiment, a label may be used as another level of grouping stream events in a single partition. By way of example, a label may correspond to a bucket name (e.g., a column name, a table name, etc.) of a bucket of CP data store 102. Stream events of a given partition and corresponding to the same label(s) may be considered to be related, while stream events of a given partition that have different, mutually exclusive labels may be considered unrelated.

Although not depicted, each of the stream events (e.g., stream events 210, 212, and 214) may include a timestamp that indicates a time at which the respective stream event was published.

As depicted in FIG. 2, stream events 204, 206, and 208 may correspond to data updates (also referred to as a “data change event”) of the same resource, as indicated by a common set of identifiers including the same message identifier (e.g., M1), the same partition identifier (e.g., P1), and the same label (e.g., L1).

Data stream 202, as depicted in FIG. 2, includes three partitions (e.g., corresponding to partition identifiers “P1,” “P2,” and “P3.” Each of these partitions may correspond to a streaming partition that represents a sub-partition of a partition utilized by streaming platform 124 of FIG. 1. Stream events 210 may correspond to partition P1, stream events 212 may correspond to partition P2, and stream events 214 may correspond to partition P3.

Returning to FIG. 1, demuxer(s) 126 may publish stream events not only by stream and partition, but also by label within the partition. By way of example, a client (e.g., DP client 104A of FIG. 1) could subscribe to all of the stream events in a stream “S1,” or all stream events corresponding to a stream and/a partition (“S1,” P1”), and/or to all stream events of a stream and one or more label combinations (“S1,” “L1,” “L2”). Each demuxer may include one or more consumers of one or more partitions (e.g., one or more partitions of partitions 130 of FIG. 1). The partitions consumed by the demuxer could belong to different data streams. Within each demuxer, at least three consumers may be created. In some embodiments, at least some consumers may be different availability domains and/or fault domains for scalability and high availability. For a large stream, it is possible that it could be hosted in multiple shards. In this case, if a single DP client needs to consume a full data stream, it may connect to all of the streaming endpoints corresponding to the demuxers that are associated with that stream. In case a single client host is interested in only a subset of data (e.g. data belonging to a single stream partition, a sub-partition of partition 130A), it may connect to single streaming endpoint (e.g., a single demuxer corresponding to the stream partition) to receive that data.

Demuxer clients may include any suitable combination of: 1) service clients (e.g., DP clients of DP client(s) 104, DP clients that have previously subscribed to the stream, the stream/partition, or label, 2) DSS instances (e.g., DSS(s) 134) that generate a recent snapshot of each data stream and its corresponding stream partitions, and/or 3) a remote-region replicator (e.g., a replicator in a different geographical region than the region in which cloud-computing environment 100 exists. A remote region replicator (e.g., a service) may be a component of the streaming service corresponding to stream service CP 120. A remote region replication may run cross-region replication tasks for different data streams. To enable cross-region replication, an inbox-stream may be created in a region within a compartment in the service team's control plane tenancy. The inbox-stream may be a data stream that does not allow direct publishing and is only used for receiving data from remote region streams. It may not allow replicating the inbox-stream or a partition in the inbox-stream to a remote region. A publisher of a data stream can enable replication of a full stream or one or more stream partitions in a data stream in a current region to an inbox-stream in a remote region by calling a control plane application programming interface via endpoint 150. The disclosed streaming service may replicate the data from streams in one or more remote regions to the corresponding inbox-stream in a current region. The service team in the current region (who owns the inbox-stream) may then be responsible for writing backfill code to backfill the replicated data from the inbox-stream to CP data store 102.

Any suitable number of demuxer(s) 126 may reside on a shard (e.g., shard 132A-N, collectively referred to as “shards 132”). A “shard” refers to a portion of a distributed database that corresponds to a partition. DP client(s) 104 may individually store data corresponding to any suitable shards/partitions. A single container (not depicted) may include multiple shards, each shard representing a different partition. Each partition may correspond to a primary shard and a configurable number of replica shards.

Each of shards 132 may include one or more instances of a Data Snapshot Service (DSS). By way of example, shard 132A may include DSS(s) 134A and shard 132N may include DSS(s) 134N. DSS(s) 134A-N may be collectively referred to as “DSS(s) 134.” In some embodiments, a shard may include one or multiple DSS instances, where some number of the DSS instances (e.g., two, three, etc.) may be replica instances that store a replica of the stream events of a given data stream. In some embodiments, the DSS(s) (e.g., DSS(s) 134A) of a shard (e.g., shard 132A) may be subscribed to receive all stream events from the demuxer(s) corresponding to the same shard (e.g., demuxer(s) 126A). In some embodiments, each DSS(s) may be configured to generate a snapshot of stream events (e.g., a copy of all previously received stream events of a given data stream and/or partition at a specific moment in time). DSS(s) 134A may be configured to provide stream events from a snapshot to DP client(s) 104, on request (e.g., based on receiving a bootstrap request from a corresponding DP client).

Discovery service 138 may be a component of the streaming service, or a separate service, that is configured to cluster configuration and metadata for all data streams hosted by the streaming service (e.g., data stream(s) 128). In some embodiments, this includes maintaining endpoint data corresponding to demuxers and DSS instances corresponding to one or more data streams/partitions.

In some embodiments, DP client(s) 104 may be configured to request endpoint identifiers for a particular partition. As a non-limiting example, demuxer(s) 126A and DSS(s) 134A may be associated with partition 130A, and demuxer(s) 126N and DSS(s) 134N may be associated with partition 130N. Each of endpoints 140-148 may correspond to an internal public cloud load balancer. Discovery service 138 may maintain a record that indicates that a data stream (e.g., data stream “S1”) is associated with endpoints 142, 144, 146, and 148, that endpoints 142 and 146 correspond to demuxer endpoints (e.g., endpoints for demuxer(s) 126A and 126N, respectively), and that endpoints 144 and 148 correspond to DSS endpoints (e.g., endpoints for DSS(s) 134A and 134N, respectively). Identifiers for endpoints 140-148 may be provided as part of a process for creating a data stream in which such data is provided (e.g., by user device 108) via endpoint 150) to streaming service CP 120. Once a DP client (e.g., DP client 104A) obtains the endpoints corresponding to a data stream and/or partition, the DP client may connect (e.g., via remote procedure call such as gRPC) to the DSS endpoints (e.g., endpoints 144 and 148) for bootstrapping. Once connected, the DP client may send a bootstrap request to the DSS endpoints, where the bootstrap request indicates the data stream(s) and/or partition(s) for which the DP client is interested in receiving stream events. During bootstrapping, the DSS(s) (e.g., DSS(s) 134A and 134N) may generate/obtain a snapshot of the stream events corresponding to a data stream and/or partition and provide the stream events of the snapshot to the DP client.

Once bootstrapping is complete (e.g., all stream events of the snapshot corresponding to a partition have been processed by the DP client), the DP client may connect (e.g., via remote procedure call) to the demuxer endpoints (e.g., endpoints 142 and 146). Once connected, the DP client may send a subscribe request to the demuxer endpoints that indicates the data stream(s) and/or partition(s) for which the DP client is interested in receiving stream events. Once subscribed, the demuxers corresponding to the endpoints may begin streaming events corresponding to the data stream/partition(s) to the DP client.

Each of DP client(s) 104 may execute a streaming service application (e.g., streaming service application 152, “application 152,” for brevity). In some embodiments, the application 152 may be deployed as an isolated process/in an isolated container. In some embodiments, the application 152 may be deployed as a sidecar application with a client data plane application (not depicted). The application 152 may be configured to consume data from one or more data streams. In some embodiments, the application 152 manages replication to persistent data store (e.g., persistent storage 154) on a local host (e.g., DP client 104A). In some embodiments, persistent storage 154 may be an embedded database that stores key-value data (e.g., data that may be retrieved by using the key as a lookup value). Replicated data (e.g., data of persistent storage 154) may be made available to the client data plane application via an API, using an inter-process communication mechanism (e.g. API bound to the loopback interface or a Linux domain socket) on the local host.

The application 152 may periodically upload the data of persistent storage 154 to block storage (not depicted). When application 152 starts, it may check for the presence of key-value data in persistent storage 154 and if it is not present, the application 152 may download the latest key-value data from the block storage and store it in persistent storage 154. If the key-value data is not available at the DP client or via block storage, then the application 152 may submit a bootstrap request to one or more DSS(s) as described above and, after bootstrapping, the application 152 may be configured to send subscription requests to one or more demuxer(s) as described above. In some embodiments, the functionality of application 152 may be provided as a thin client library. The library may enable service teams to implement the features of sidelining (e.g., pausing replication of a poison-pill affected partition) and un-sidelining (e.g., recovering/catching up a previously sidelined partition).

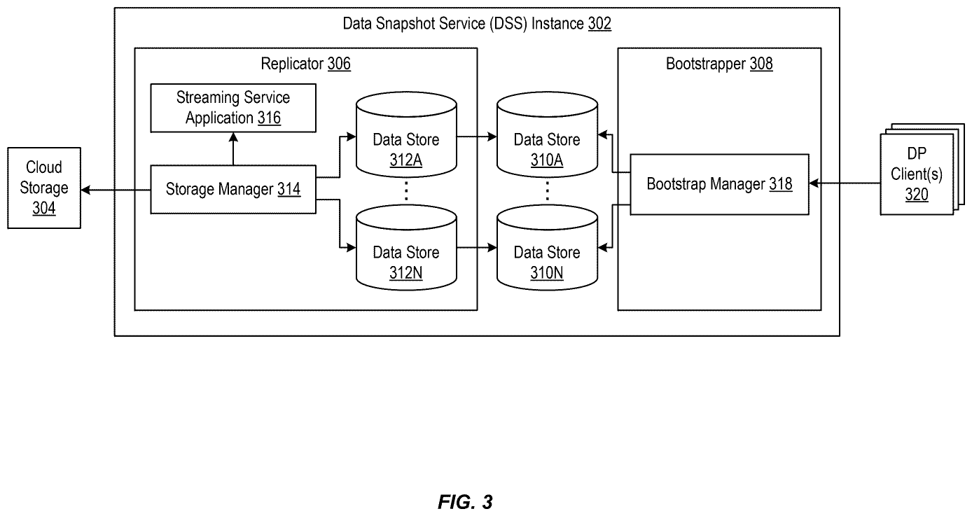

FIG. 3 is a block diagram depicting an example Data Snapshot Service (DSS) instance, according to at least one embodiment. The DSS instance 302 (e.g., an example of DSS(s) 134) may implement a highly available data plane bootstrap service that may be responsible for generating and storing snapshots of the data streams, along with all the stream partitions (e.g., a logical grouping of stream events that differs from the grouping identified by partitions 130 of FIG. 1, logical grouping of stream events that represents a subset of the stream events of partition 130A, etc.) for the data streams for which it is subscribed. DSS instance 302 may be configured to: 1) discover new data streams dynamically, 2) ingest and persist stream events from demuxers associated with the same shard to which DSS instance 302 corresponds, 3) allow DP clients to resume bootstrap on disconnection, 4) allow DP clients to bootstrap records in insertion order, 5) allow DP clients to bootstrap at any suitable data stream/partition/label granularity, 6) provide a snapshot isolated view of data stream events of a data stream at the time of serving bootstrap requests, 7) provide data isolation between data streams, 8) generate periodic backups of snapshots and upload to cloud storage 304, and the like.

DSS instance 302 may include replicator 306 and bootstrapper 308. Replicator 306 and bootstrapper 308 may execute as separate containers/isolated execution environments (e.g., Docker containers) and may be both configured to access to data stores 310 (e.g., data store 310A-N). In some embodiments, replicator 306 and bootstrapper 308 may share a common data volume mount which enables access to data stores 310.

Replicator 306 may include store manager 314. Store manager 314 may be a singleton managed object that is configured for discover data streams by querying streaming service application 316 (e.g., an application corresponding to the streaming service discussed in connection with FIG. 1). Querying streaming service application 316 may cause the application to transmit a request to streaming service CP 120 of FIG. 1 to request a set of current data streams. The current data streams may be compared to a set of data streams maintained by the streaming service application 316 and corresponding to data stores 312. Data streams in the current set for which a corresponding data store 312 does not exist may be identified. In some embodiments, the store manager 314 may be instructed to initialize a new data store (e.g., a new data store of data stores 312).

Store manager 314 may be configured to manage gRPC channels (e.g., with corresponding demuxers), to manage an executor responsible for running blocking operations such as file I/O, and/or to manage the lifecycle of each of the data stores 312. Store manager 314 may run scheduled jobs to periodically discover new data streams or to archive data stores for data streams that no longer exist. Telemetry, limit enforcement, and store backups may also be performed by the store manager 314. In some embodiments, store manager 314 may be responsible for health-checks and graceful termination of stores during shutdown.

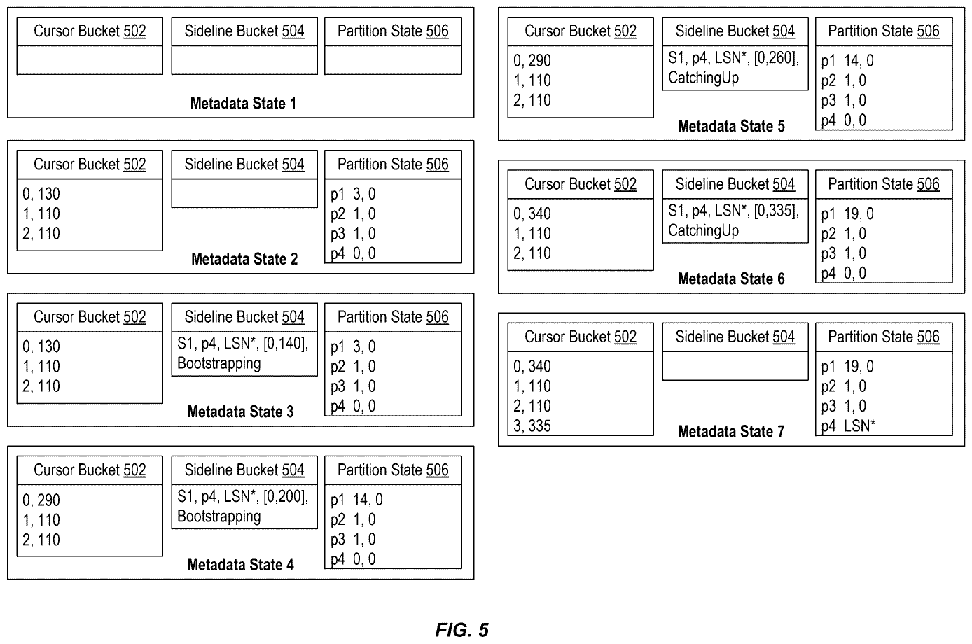

Each of data stores 312 may be a key-value data store. In some embodiments, data stores 312 may individually include an embedded key-value database library that provides scalable, high-performance, transaction-protected data management services to applications (e.g., Berkeley DB Java Edition, rocksDB, etc.). Each of the data stores 312 may be specific to a data stream. Each of data stores 312 may be used to track every stream event published by demuxer(s) 126 for a respective data stream to which the DSS instance 302 is subscribed, including any suitable stream events corresponding to one or more partitions that are associated with a common data stream identifier. The metadata of FIG. 5 that is discussed below in relation with a DP client, may similarly be maintained in data stores 312. Each stream event may be identified by a tuple (e.g., {partition identifier, label, message identifier} within data stores 312. In some embodiments, data stores 312 may individually use an append-only log to store stream events such that new stream events are appended to the end of a log file until the log file fills up. Once full, the log may be written to a corresponding data store (e.g., data store 310A) of data stores 310. Stream events from different data streams may not be shared in a single data store of data stores 312. A snapshot of a data stream (retrieved from a data store of data stores 310) may include stream events of one or more of data stores 312. That is, in some embodiments, data store 310A may store only stream events corresponding to a single data stream.

The DSS instance 302 may be initialized or may recover in the event of a catastrophic failure based at least in part on downloading the previously stored log files from cloud storage 304, un-tar'ing them in a directory, and pointing the key-value store database library of a data store to that directory. This alleviates the need for manually copying files as found in conventional systems.

Replicator 306 may include an exception listener (e.g., as part of streaming service application 318, as part of the key-value database library of data store(s) 312, etc.) that can be used to invalidate a data store of data stores 312 when certain kinds of exceptions are thrown. Some example exceptions may include but are not limited to the following exceptions provided in the table below.

| Exception | Description |
|---|---|
| Input/Output | Thrown during decompression of a stream event if a compressor |
| | input stream cannot be converted to a data payload. |
| Compression | Thrown during decompression of a stream event if the |
| | compressor algorithm is not supported. |
| Illegal State | Thrown if a composite key deletion is encountered. |
| Illegal Protocol Buffer | Thrown if TokenPairValue cannot be parsed from TokenPair. |
| Illegal Argument | Thrown if 1) an invalid transaction id, an invalid index, or an |
| | unsupported primary index is supplied in a bucket GET or bucket |
| | PUT operation, or 2) if compression algorithm and stream are |
| | null during decompression of a stream event. |
| Class Cast | Thrown on type cast mismatches. |
| Null Pointer | Thrown when null parameters are encountered when attempting a |
| | bucket operation. |
| CP Store Internal | Thrown if a read request of CP data store 102 of FIG. 1 cannot |
| | serialize a ColumnValueSet. |
| Decreasing LSN | Thrown if an out of order stream event LSN is encountered. |
| Secondary Integrity | Thrown if a primary-secondary relationship integrity problem is |
| | detected when writing a record in a primary database that has one |
| | or more secondary indices. |
| Secondary Constraint | Corresponds to a superclass of all exceptions thrown when a |
| | write operation fails because of a secondary constraint. Thrown if |
| | any exception of the superclass is thrown. |
| Duplicate Key | Thrown when a commit of CP data store 102 would cause a |
| | duplicate key in a unique index. |
| Commit Conflict | Thrown when a commit of CP data store 102 encounters a |
| | serialization conflict. |

When the exception listener of replicator 306 detects one of a predefined set of exceptions (e.g., the exceptions of the table above), the streaming service application 318 or store manager 316 may be invoked or configured to sideline the partition. Sidelining the partition may include storing sideline metadata for the partition that indicates the offset/sequence number of the stream event that caused the exception to be thrown. While sideline metadata is stored for the partition (e.g., indicating that the partition is sidelined), stream events received from the demuxer may be ignored. In this manner, processing stream events for the partition is halted/restricted. The replicator 306 (e.g., the streaming service application 318, store manager 316, etc.) may be configured to ignore/discard stream events for all sidelined partitions until a control event is received from streaming service CP that indicates the issue corresponding to the exception has been remediated and/or that the partition should no longer be sidelined. Upon receiving such a message, the sideline metadata for the partition may be deleted and the DSS instance may transmit a subscribe request to the corresponding demuxer that requests stream events once more from the data stream/partition. In some embodiments, the subscribe request may include a cursor (e.g., a cursor that is of a particular type corresponding to a demuxer cursor) that indicates a position that occurs in the data stream prior to the stream event that originally caused the thrown exception.

In some embodiments, the exceptions may be detected by a DP client and provided to a demuxer (e.g., via a sideline request message corresponding to the data stream and/or partition), which in turn may provide the sideline request message to the DSS instance 302. In some embodiments, streaming service application 318 may receive the sideline request message and may be configured to store sideline metadata (e.g., a sideline state associated with the partition, sideline metadata received in the sideline request message) in memory. While the sideline metadata is stored in memory (e.g., in data store 312A) the bootstrap manager 318 may be configured to reject all bootstrap requests for that partition. In some embodiments, the sideline metadata may be deleted by the streaming service application 318 upon receipt of a control event (e.g., from a demuxer) that indicates the issue corresponding to the exception has been remediated and/or that the partition should no longer be sidelined. Deleting the sideline metadata may cause the partition to be “unsidelined” and for subsequent bootstrap requests to no longer be restricted/blocked.

Bootstrapper 308 may include bootstrap manager 318. Bootstrap manager 318 may be configured to receive and process bootstrap requests from DP client(s) 320 (e.g., DP client(s) 104 of FIG. 1). In some embodiments, a bootstrap request may correspond to a data stream (the data stream corresponding to one of data stores 310. As the DSS instance 302 operates at a shard corresponding to a streaming platform partition, the data stores 310 may individually correspond to a streaming platform partition. The bootstrap manager 318 may be configured to open, in read-only mode, a data store of data stores 310 (e.g., data store 310A) that corresponds to the requested data stream/streaming platform partition. When data store 310A is opened in read-only mode, bootstrap manager 318 may access a snapshot view of the database at the time of opening. In some embodiments, no new mutations (e.g., data change events corresponding to stream events) may be observed by the data store 310A unless it's closed and re-opened. This approach is advantageous given that the bootstrap manager 318 may access a snapshot view of the database without blocking reads or writes by the replicator 306.

Bootstrapper 308 may be configured to perform a bootstrap of a data stream/streaming platform partition using a snapshot of stream events corresponding to the data stream/streaming platform partition. When a DP client of DP client(s) 320 first starts up may be initialized with an empty state. In this state, the DP client may be configured to first reach out to the DSS instance 302 to perform a bootstrap of the data stream/streaming platform partition, before connecting to a demuxer to stream the latest stream events. An example process to bootstrap the data stream/streaming platform partition at the DP client may include the following steps.

At step 1, a DP client (one of DP client(s) 320) may transmit a bootstrap request to DSS instance 302. The bootstrap request may include a stream identifier for the data stream for which the bootstrap is desired. The bootstrap request may include a partition identifier and/or one or more labels with which data events of a snapshot may be filtered. In some embodiments, the bootstrap request may include resumption token (e.g., a sideline cursor corresponding to an DSS specific resumption token, a demuxer specific resumption token, etc.) that indicates a position within the data stream at which the bootstrap of the data stream is to commence (or recommence, if a previous bootstrap was interrupted and the DP client is resuming a previously initiated bootstrap of the data stream). If the DP client is connecting to the DSS instance 302 after being connect to a demuxer, then the bootstrap manager 318 may first convert the demuxer resumption token to an DSS resumption token.

At step 2, the bootstrap request may be intercepted by an auth server handler that may be configured to ensure that the bootstrap request is authenticated and authorized before forwarding it to the bootstrap manager 318. If AuthN/AuthZ checks fail, then the bootstrap request may be immediately rejected with either an ‘UNAUTHENTICATED’ or a ‘NOT_FOUND’ error.

At step 3, the bootstrap manager 318 may open a read-only (RO) handle on the data store corresponding to that particular data stream (e.g., data store 310A). The RO handle may provide a snapshot view of the database corresponding to the time at which the handle was opened. In some embodiments, the bootstrap manager 318 may check to see if resumption from the offsets provided in the DSS specific resumption token received/converted in step 1 leads to data loss. If so, the bootstrap request may be rejected with a “DATA_LOSS” gRPC status code.

The bootstrap manager 318 may check to see if the offsets provided in the DSS specific resumption token (e.g., a streaming cursor that identifies the last successfully processed stream event processed by the DP client) are ahead of the offsets in the DSS instance 302 (e.g., an DSS cursor that identifies the stream event last streamed for a stream/partition). If so, the bootstrap manager 318 may mark the bootstrap request as completed to notify the DP client that it can try to connect to demuxer as DSS itself is behind the DP client in this case.

At step 4, the bootstrap manager 318 may initialize a cursor on the first entry of the data stream (or at a position corresponding to a cursor provided with the bootstrap request) and start scanning the bootstrap table, optionally filtering stream events using those cursors. The bootstrap manager 318 may be configured to attach an DSS specific resumption token to each stream event that is sent to the DP client so the DP client can resume from where it left off in the event that it disconnects before the bootstrap concludes. The DSS specific resumption token may be used to update a sideline cursor maintained by the DP client to keep track of a position in the data stream that corresponds to the last stream event that was successfully processed during the bootstrap. In some embodiments, the bootstrap manager 318 may accumulate a batch of stream events in a buffer (e.g., 1000 stream events, 100 stream events, etc.) before sending the batch to the DP client in a single bootstrap response.

At step 5, once the bootstrap manager 318 has completed sending all the stream events for the data stream, it may be configured to send an update resumption token control event that includes a demuxer specific resumption token (e.g., corresponding to a streaming cursor utilized by the demuxer) that the DP client can use to subscribe with the demuxer to obtain stream events that correspond to subsequent stream events occurring after the last stream event of the snapshot. In some embodiments, the demuxer specific resumption token is made available only when bootstrap is fully complete to restrict the DP client from subscribing to the data stream with the demuxer when a bootstrap has not been completed.

At step 6, the bootstrap manager 318 may mark the bootstrap request as complete and may notify the DP client that it can now connect to the demuxer to begin/resume ingestion using the demuxer specific resumption token provided by DSS. In some embodiments, the demuxer specific resumption token may be provided in the same message that indicates the bootstrap has completed.

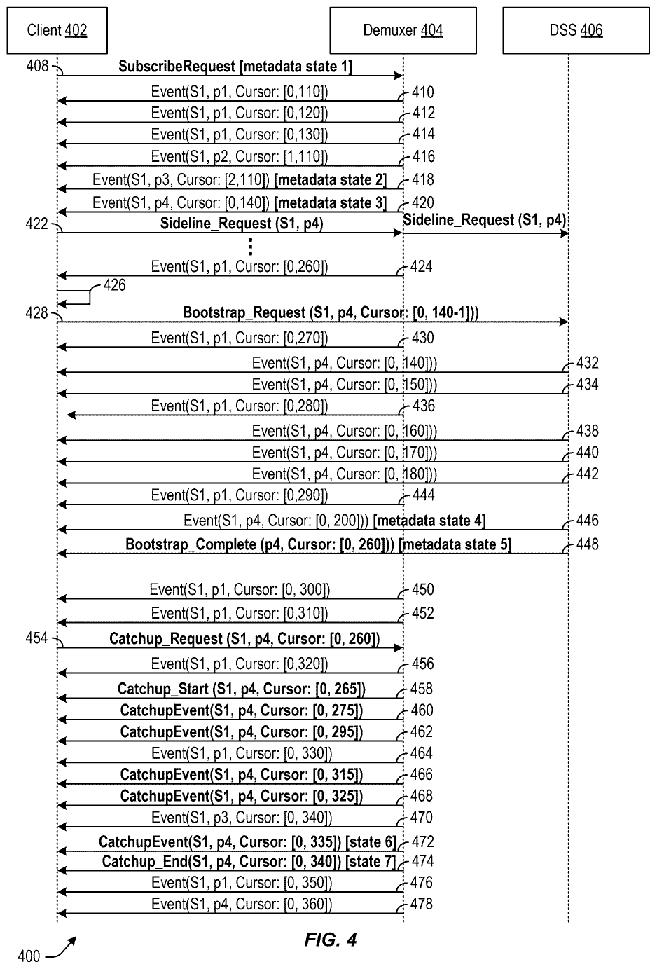

FIG. 4 is a flow 400 depicting operations for sidelining and automatically catching up a previously sidelined partition, according to at least one embodiment. The operations of flow 400 may be performed with client 402 (e.g., DP client 104A of FIG. 1), demuxer 404 (e.g., one of demuxers 126A of FIG. 1), and DSS 406 (e.g., a Data Snapshot Service instance such as one of DSS(s) 134A of FIG. 1). It may be presumed that client 402 has previously opened a channel with demuxer 404 (e.g., by gRPC) prior to the operations of flow 400.

At any suitable time, client 402 may initialize metadata for tracking the processing of each partition of the data stream. As a non-limiting example, a streaming service application (e.g., streaming service application 152 of FIG. 1) executing on the client 402 may maintain or obtain a set of data streams and one or more stream partition identifiers (e.g., identifiers corresponding to sub-partitions of partitions 130 of FIG. 1). The client 402 may initialize in memory persistent storage (e.g., persistent storage 154, an example of the data stores 312) for identified each data stream. Persistent storage 154 may include a database library (e.g., store manager 316 of FIG. 3) that stores key-value data. The client 402 may initialize the database library with metadata state data.

FIG. 5 is a block diagram depicting example metadata states corresponding to the flow of FIG. 4, according to at least one embodiment. Metadata state 1 of FIG. 5 is intended to depict initialized buckets of the key-value store. The initialized buckets may correspond to a single data stream may include cursor bucket 502, sideline bucket 504, and partition state 506. Each of the buckets 502-506 may store entries corresponding to any suitable partition (e.g., stream partitions that correspond to a respective set of sub-partitions of partition 130A of FIG. 1).

Cursor bucket 502 may be utilized by a data plane client (e.g., DP client 104A of FIG. 1) to store streaming cursors for each partition (e.g., a stream partition that corresponds to a subset of stream events of partition 130A of FIG. 1). A streaming cursor (e.g., a pair of values corresponding to a streaming platform partition and an offset/sequence number assigned by the streaming platform 124 and corresponding to the stream event) may be used by a demuxer to maintain a respective position within each partition that indicates the last successfully processed stream event for a given streaming platform partition (e.g., a Kafka partition). The cursors stored in cursor bucket 502 may be received in a stream event provided by a demuxer. In some embodiments, many buckets similar to cursor bucket 502 may be initialized, one corresponding to each data stream.

In some embodiments, sideline bucket 504 may be utilized by the data plane client to store metadata related to one or more sidelined partitions (e.g., stream partitions (sub-groupings of partitions 130) for which replication is currently being blocked due to an exception being detected during processing of a previously received stream event). In some embodiments, the sideline bucket may include one or more entries that individually include a stream identifier, a stream partition identifier (e.g., corresponding to a stream partition, a sub-partition of the partition 130A of FIG. 1), an LSN including a sequence number and an order, a streaming cursor including a streaming platform partition and an offset/sequence number assigned by the streaming platform 124, and a state value. In some embodiments, many buckets similar to sideline bucket 504 may be initialized, one corresponding to each data stream.

In some embodiments, partition state 506 may be utilized by the data plane client to store any suitable partition metadata such as a partition identifier (e.g., “p1”), a sequence number corresponding to the stream event/partition, an order corresponding to the log sequence numbers for the partition, and/or log sequence numbers that correspond to a demuxer cursor. Each stream event received may include an LSN (e.g., a pair of values such as a log sequence number and an order) and a partition identifier (e.g., “p4”). Partition state 506 may be used to store the LSN for each stream partition as received in the last successfully processed stream event for a given partition. In some embodiments, the LSN of a given partition may be saved in partition state 506 only when the stream event is received from a demuxer and not when the stream event is received from an DSS instance. If a client 402 receives an event with a LSN for a partition that is equal to or smaller than the one stored for that partition in partition state 506, then the client 402 may ignore that stream event. The client 402 can choose to alarm in such cases and log the offsets and LSN along with partition identifier for debugging purposes.

Returning to FIG. 4, Flow 400 may begin at 408, where client 402 may transmit a subscribe request message to demuxer 404. In some embodiments, the subscribe request message may indicate one or more subscription targets (e.g., data streams, labels, and/or partitions to which the client is requesting to subscribe). The subscribe request message may include any suitable combination of one or more data stream identifiers, one or more streaming platform partition identifiers (e.g., an identifier for partition 130A), and/or one or more labels. In the example provided in FIG. 4, the data stream may be associated with three partitions (e.g., streaming platform partitions of data stream S1, including partition 130A) and four stream partitions (e.g., corresponding to four sub-groupings for stream events of data stream S1). As a non-limiting example, the subscribe request message transmitted at 408 may indicate a subscription target of the data stream “S1” based at least in part on including a data stream identifier corresponding to the data stream “S1” in the subscribe request message. In some embodiments, the subscribe request message may include a streaming cursor (e.g., a pair of values indicating a streaming platform partition and an offset/sequence number) that indicates (e.g., based on the offset/sequence number) the last stream event that was successfully processed for a streaming platform partition (e.g., partition 130A, a Kafka partition). In some embodiments, if no previous stream events have been received for a data stream and/or streaming platform partition, the streaming cursor may include a default value that is predefined to indicate that the client 402 has not received any previous stream events for the data stream and/or streaming platform partition (e.g., partition 130A).

Subsequent to receiving the subscribe request at 408, demuxer 404 may maintain record of the subscription targets for client 402. As demuxer 404 receives stream events from a streaming platform (e.g., streaming platform 124 of FIG. 1), it may serve those stream events to one or more clients, including client 402, in accordance with the subscription targets it maintains. Each of the “events” (e.g., stream events) depicted in FIG. 4 are intended to relate to the data stream “S1,” through inclusion of a stream identifier “S1.” Each stream event transmitted by demuxer 404 may include a streaming cursor (e.g., a pair of values that include a streaming platform partition identifier and an offset/sequence number assigned to the stream event by the streaming platform 124). The demuxer 404 may be configured to provide each stream event in the form of a subscribe response message. In some embodiments, the demuxer 404 may be configured to provide stream events that are associated with the same streaming platform partition and offsets that occur after the offset indicated by the cursor provided in the subscribe request message.

At 410, a stream event with an LSN corresponding to partition p1 (e.g., a stream partition of the data stream) and streaming cursor [0, 110] may be transmitted, where 0 corresponds to a first streaming platform partition, and 110 corresponds to the offset/sequence number assigned by streaming platform 124.

At 412, another stream event with an LSN corresponding to partition p1 streaming cursor [0, 120] may be transmitted, where 0 corresponds to the first streaming platform partition, and 120 corresponds to the offset/sequence number assigned by streaming platform 124.

At 414, another stream event with an LSN corresponding to partition p1 streaming cursor [0, 130] may be transmitted, where 0 corresponds to the first streaming platform partition, and 130 corresponds to the offset/sequence number assigned by streaming platform 124.

At 416, a stream event with an LSN corresponding to partition p2 (e.g., a stream partition of the data stream) and streaming cursor [1, 110] may be transmitted, where 1 corresponds to a second streaming platform partition, and 110 corresponds to the offset/sequence number assigned by streaming platform 124.

At 418, a stream event with an LSN corresponding to partition p3 (e.g., a stream partition of the data stream) and streaming cursor [2, 110] may be transmitted, where 2 corresponds to a third streaming platform partition, and 110 corresponds to the offset/sequence number assigned by streaming platform 124.

The client 402 may be configured update the cursor bucket 502 of FIG. 5 with the streaming cursors and partition state 506 with the LSNs of successfully processed stream events, as the stream events are successfully processed. Metadata state 2 of FIG. 5 is intended to depict the values maintained in cursor bucket 502, sideline bucket 504, and partition state 506 after successful processing the stream event transmitted at 418. Of note, the last streaming cursors of the last successfully processed stream event for each partition may be stored in cursor bucket 502. As depicted in metadata state 2, cursor bucket 502 may include streaming cursor [0, 130] corresponding to the first streaming platform partition, indicating that the stream event with offset/sequence number 130 (e.g., the stream event transmitted at 414) was the last stream event that was successfully processed in the first streaming platform partition. As depicted in metadata state 2, cursor bucket 502 may include streaming cursor [1, 110] corresponding to the second streaming platform partition, indicating that the stream event with offset/sequence number 110 (e.g., the stream event transmitted at 416) was the last stream event that was successfully processed in the second streaming platform partition. As depicted in metadata state 2, cursor bucket 502 may include streaming cursor [2, 110] corresponding to the third streaming platform partition, indicating that the stream event with offset/sequence number 110 (e.g., the stream event transmitted at 418) was the last stream event that was successfully processed in the third streaming platform partition.

Partition state 506 may be updated to include the LSNs corresponding to the last successfully processed stream events for each stream partition (e.g., stream partitions p1, p2, p3, and p4 of the data stream).

Although not depicted, it should be appreciated client 402 may be configured to aggregate stream events for a single stream partition together (e.g., a stream partition that corresponds to a subset of stream events of partition 130A), in the order received, to generate a batch of stream events which then may be committed to the key-value store as a single transaction (e.g., via a single PUT transaction). For example, the stream events for partition p1 may be aggregate and committed as a single PUT transaction and may result in a single update of the metadata stored at client 402 where the streaming cursor and partition state data for p4 is updated in cursor bucket 502 and partition state 506 once, as opposed to updating such data for each, individual stream event of partition p1, as they are successfully processed.

Returning to FIG. 4, at 420, a stream event with an LSN corresponding to partition p4 (e.g., a stream partition that corresponds to a subset of stream events of partition 130A) and streaming cursor value [0, 140] may be transmitted, where 0 corresponds to the first streaming platform partition, and 140 corresponds to the offset/sequence number assigned by streaming platform 124.

In some embodiments, an exception may be thrown at the client 402 due to the receipt or attempted processing of the stream event received at 420. The client 402 may include an exception listener similar to that discussed in connection with replicator 306 of FIG. 3. Upon detecting one of a predefined set of exceptions (e.g., the exceptions provided in the table above), the client 402 may sideline the partition to which the stream event that caused the exception relates. In some embodiments, one or more retries for processing the stream event may be required to be attempted before the client 402 is configured to sideline the partition. Sidelining the partition may include storing an entry in sideline bucket 504 of FIG. 5 with metadata corresponding to the partition that is being sideline. As a non-limiting example, the entry of sideline bucket 504 may include a data stream identifier (“S1”), a partition identifier (e.g., “p4,” corresponding to a stream partition of partition 130A), a pointer corresponding to an LSN for the partition, and streaming cursor corresponding to the stream event, and a recovery state of the sidelined bucket.

Metadata state 3 of FIG. 5 is intended to depict the partition metadata stored in response to detecting one of a predefined set of exceptions based at least in part on receipt of the stream event at 420. As depicted in FIG. 5, the sideline metadata may include the set {S1, p4, LSN*, streaming cursor:[0, 140] (e.g., the streaming cursor of the event that caused the exception to be thrown), and a recovery state (e.g., BOOTSTRAPPING). In some embodiments, the client 402 may transmit a sideline request message at 422 to indicate the partition p4 of data stream S1 has been sidelined. In some embodiments, the demuxer 404 may provide a control event to DSS 406 that indicates that the partition p4 of data stream S1 has been sidelined. The DSS 406 may store any suitable data that indicates that partition p4 is sidelined.

While in the recovery state BOOTSTRAPPING, the client 402 of FIG. 4 may be configured to periodically transmit bootstrap requests for the partition to DSS 406. However, while the data stored by DSS 406 indicates that p4 is sidelined, these bootstrap requests may be rejected/ignored/blocked. In some embodiments, a user-initiated control event that indicates the issue that caused the p4 partition to be sidelined has been corrected. This control event may be received by demuxer 404 and consumed by DSS 406 and client 422. Upon consuming the control event, the DSS 406 may delete any suitable data that indicates that the partition p4 of data stream S1 is sidelined. Subsequent bootstrap requests for the partition may be processed. In some embodiments, the client 402 may be configured to transmit a bootstrap request for the partition only after receiving a control event that indicates the issue corresponding to the exception has been correct and/or indicating that a catchup process for the sidelined partition should commence.

In some embodiments, while partition p4 is sidelined, the demuxer 404 may continue to send stream events for any suitable combination of partitions p1-p4. For example, at 424, a stream event with an LSN corresponding to partition p1 and streaming cursor [0, 160] may be transmitted, where 0 corresponds to the first streaming platform partition, and 160 corresponds to the offset/sequence number assigned by streaming platform 124.

At 426, client 402 may initiate a catching up process for partition p4 (e.g., based at least in part on receiving a control event indicating the issue that caused the p4 partition to be sidelined has been corrected).

As part of the catching up process, client 402 may transmit a bootstrap request at 428. In some embodiments, the bootstrap request may include a data stream identifier (“S1”), a partition identifier (e.g., “p4” corresponding to the sidelined partition), and a cursor value that is identified based on the streaming cursor corresponding to the first streaming platform partition. In some embodiments, the streaming cursor may be modified to an offset that is less that the offset of the cursor provided in the stream event received at 420. By way of example, the bootstrap request may include streaming cursor: [0, 139] corresponding to 1 less than the value 140 corresponding to the offset of the streaming cursor corresponding to the stream event received at 420.

The demuxer 404 may continue to send stream events for any suitable combination of partitions p1-p4 at any suitable time (e.g., any suitable time after the bootstrap request at 428). For example, at 430, a stream event with an LSN corresponding to partition p1 and streaming cursor [0, 270] may be transmitted, where 0 corresponds to the first streaming platform partition, and 270 corresponds to the offset/sequence number assigned by streaming platform 124.

In response to the bootstrap request received at 428, the DSS 406 (e.g., bootstrap manager 318 of FIG. 3) may generate a snapshot of the data stream events received to date and transmit any suitable stream events occurring in a snapshot after the offset indicated by the streaming cursor provided in the bootstrap request. As an example, the snapshot may include each of the stream events identified above, to offset 260 of the data stream.

At 432, DSS 406 may transmit a stream event with an LSN corresponding to partition p4 (e.g., a stream partition that corresponds to a subset of stream events of partition 130A) and streaming cursor value [0, 140], where 0 corresponds to the first streaming platform partition, and 140 corresponds to the offset/sequence number assigned by streaming platform 124. The stream event may be identical to the stream event that was originally received from the demuxer 404 at 420. Since the issue causing the original exception has been resolved. Client 402 may successfully process the stream event received at 432 and may update the sideline metadata accordingly. The DSS 406 may incrementally transmit sequential stream events of the snapshot. For example, the DSS 406 may transmit the stream events as depicted at 434, at 438-442, and at 436. Demuxer 404 may continue transmitting stream events at any suitable time. For example, demuxer may transmit stream events as depicted at 436 and 444.

Metadata state 4 of FIG. 5 is intended to depict the partition metadata stored in response to successfully processing the stream event received by the client 402 at 446. As depicted in FIG. 5, the partition metadata may include sideline metadata:{S1, p4, LSN*, streaming cursor:[0, 200] (e.g., the streaming cursor of the stream event received at 446), and a recovery state (e.g., BOOTSTRAPPING).

Now returning to FIG. 4. Presuming that, in this example, the stream event corresponding to streaming cursor [0, 200] is the last stream event corresponding to p4 of the snapshot utilized by DSS 406, DSS 406 may transmit a bootstrap complete message at 448. In response to receiving the bootstrap complete message, the client 404 may update the partition metadata.

For example, metadata state 5 of FIG. 5 is intended to depict the partition metadata stored in response to receiving the bootstrap complete message at 448. As depicted in FIG. 5, the partition metadata may include sideline metadata: {S1, p4, LSN*, streaming cursor: [0, 260] (e.g., the streaming cursor of the stream event received at 446), and a recovery state (e.g., CATCHING UP).

Returning to FIG. 4, demuxer 404 may transmit stream events at 450 and 452 that correspond to offsets 300 and 310, respectively. At any suitable time after receiving the bootstrap complete message at 448, the client 402 may be configured to transmit a catchup request message to demuxer 404. By way of example, the client 402 may transmit catchup request message at 454. In some embodiments, the catchup request message may include the data stream identifier (“S1”) and an LSN that includes the stream partition identifier (“p4”) and the streaming cursor received in the bootstrap complete message received at 448.

The demuxer 404 may continue to transmit stream events. For example, at 456, demuxer 404 may transmit a stream event corresponding to partition p1 and offset 320.

In response to receiving the catchup request corresponding to p4 transmitted at 454, the demuxer 404 may identify stream events corresponding to stream partition p4 that are associated with an offset that occurs after the offset of the cursor provided in the catchup request.

At 458, demuxer 404 may transmit a catchup start message that indicates a streaming cursor of [0, 265]. The client 402 may be configured to update the LSN and streaming cursor of the sideline data maintained in sideline bucket 504 of FIG. 5 based at least in part on receiving the catchup start message. Demuxer 404 may transmit catchup stream events at 460, 462, 466, 468, and 472. Other stream events corresponding to any suitable stream partition may be transmitted by the demuxer 404 while the catchup stream events are ongoing. For example, demuxer 404 may transmit stream events at 464 and 470 corresponding to partitions p1 and p3, respectively, and offsets 330 and 340, respectively.

Metadata state 6 of FIG. 5 is intended to depict the partition metadata stored in response to receiving the catchup stream event at 472. As depicted in FIG. 5, the partition metadata may include sideline metadata: {S1, p4, LSN*, streaming cursor: [0, 335] (e.g., the streaming cursor of the stream event received at 446), and a recovery state (e.g., CATCHING UP).

Returning to FIG. 4, when demuxer 404 identifies that there are no more stream events corresponding to p4 to transmit, the demuxer 404 may transmit a catchup end message to client 404 that includes the streaming cursor corresponding to the last stream event that was successfully processed for data stream S1. By way of example, the streaming cursor transmitted at 474 may include the streaming cursor: [0, 340], corresponding to the streaming cursor of stream event transmitted at 470 (e.g., the last stream event that was successfully processed).

Receiving the catchup end message may cause/trigger the client 402 to delete the entry of sideline bucket 504 that corresponds to p4, thus, unsidelining the partition p4. In some embodiments, the client 402 may store the LSN corresponding to the stream event that corresponds to streaming cursor [0, 340] in the partition state 506, in an entry corresponding to p4.

Metadata state 7 of FIG. 5 is intended to depict the partition metadata stored in response to receiving the catchup stream event at 472. As depicted in FIG. 5, the sideline metadata corresponding to p4 has been deleted and the LSN corresponding to the stream event that corresponds to streaming cursor [0, 340], has been stored in the partition state 506, as being associated with partition p4.

Returning to FIG. 4, at 476, demuxer 404 may transmit a stream event corresponding to partition p1 and offset 350.

At 478, demuxer 404 may transmit a stream event corresponding to partition p4 and offset 360. Since p4 is no longer sidelined (as identified based at least in part on there being no entry in sideline bucket 504 that corresponds to partition p4), client 402 may process the stream event transmitted at 478 and may update the streaming cursor corresponding to partition 0 within cursor bucket 502.

Using the techniques described above, a stream partition (e.g., p4, a stream partition representing a subgrouping of a partition (e.g., partition 130A) utilized by the streaming platform 124) may be sidelined when one of a predefined set of exceptions is detected by the client 402. While sidelined, replication (e.g., processing of stream events from the demuxer 404) at the data store may be halted/restricted/blocked only for sidelined partitions, while replication continues for active partitions (e.g., stream partitions which are not currently sidelined, stream partitions for which sideline metadata does not currently exist). After the issue that originally caused the exception is resolved, the client 402 may perform an automatic catchup procedure to catch the sidelined partition up to an offset corresponding to the last stream event transmitted by the demuxer and successfully processed by a client. The automated catch up procedure may include executing a bootstrap process and/or a catch up process. In some embodiments, the bootstrap process may be followed by the catch up process. When executing the bootstrap process, the client 402 may obtain stream events from a snapshot based on requesting a bootstrap of the sidelined partition from DSS 406. Processing the stream events from DSS 406 may largely catch the data store up with respect to the stream events for the sidelined partition. Once stream events of the snapshot that correspond to the sidelined partition are exhausted, the client 402 may transmit a catch up request to obtain more current stream events (e.g., stream events that were transmitted by the demuxer 404 after the snapshot utilized by the DSS 406 was generated). The catch up request may indicate an offset corresponding to the last of the stream events processed during the bootstrap process and may cause the demuxer 404 to transmit stream events for the requested partition of the data stream that occurred after an offset indicated in the request. Once the demuxer 404 identifies that the current streaming cursor of the data stream has been reached and/or that there are no more stream events that correspond to the sidelined partition, the data store corresponding to the partition may be considered caught up, and the partition may be unsidelined. Any suitable sideline metadata corresponding the sidelined partition that was used to track the bootstrap process and/or catch up process may be deleted when the partition is unsidelined. The execution of the bootstrap and catch up processes may synchronize the data store with the demuxer such that the data store includes the stream events received for the partition after the error that caused the partition to be sidelined was originally detected. After unsidelining the partition, the client 402 may process any subsequent stream events from the demuxer 404 which correspond to the now-active partition, p4.

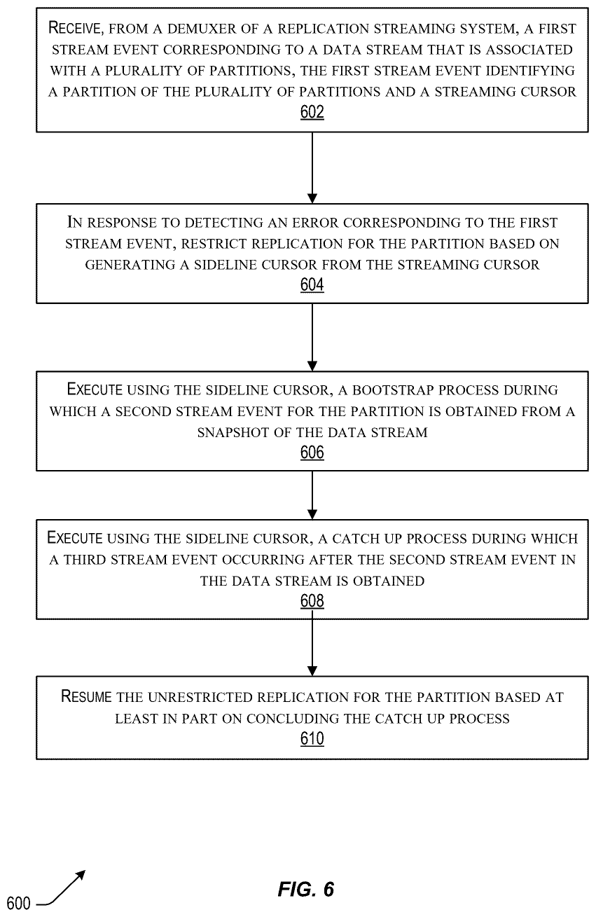

FIG. 6 is a block diagram depicting an example method 600 for sidelining a partition due to detecting an error and automatically resuming replication for the partition, according to at least one embodiment. The method 600 may be performed by any suitable component of a streaming service (e.g., the DSS(s) 134 of FIG. 1, the DP client(s) 104 of FIG. 1, etc.). Method 600 may include more or fewer operations than the number shown in FIG. 6. In some embodiments, the operations of method 600 may be performed in any suitable order.

At 602, a first stream event corresponding to a data stream that is associated with a plurality of partitions may be received (e.g., from a demuxer of demuxer(s) 126 of FIG. 1, a component of a replication streaming system (e.g., replication streaming environment 100 of FIG. 1). In some embodiments, the first stream event identifies a partition of the plurality of partitions and a streaming cursor (e.g., a pair of values indicating a stream platform partition such as “0” and an offset such as “140”, as depicted in the stream event transmitted at 420 of FIG. 4). In some embodiments, the device performing the method 600 (e.g., one of the DSS(s) 134 of FIG. 1, one of the DP client(s) 104 of FIG. 1, etc.) tracks unrestricted replication for the partition using the streaming cursor.

At 604, the device performing method 600 may restrict replication of the partition based on generating a sideline cursor from the streaming cursor. In some embodiments, restricting replication for the partition may include blocking/ignoring subsequent stream events for that partition which are not transmitted as part of a bootstrap process or a catch up process initiated by the device. In some embodiments, the replication is restricted for the partition in response to detecting an error corresponding to the stream event (e.g., one of the exceptions identified in the table above).

At 606, a bootstrap process (e.g., beginning with a bootstrap request such as the bootstrap request transmitted at 428 of FIG. 4, and ending with a bootstrap complete message such as the message transmitted at 448 of FIG. 4) may be executed using the sideline cursor. During the bootstrap process, a second stream event for the partition is obtained from a snapshot of the data stream. Any suitable stream event discussed at 432, 434, 438-442, and 446 of FIG. 4 may be an example of the second stream event.

At 608, a catch up process (e.g., beginning with a catch up request such as the catch up request transmitted at 454 of FIG. 4, and ending with a catch up end message such as the message transmitted at 474 of FIG. 4) may be executed using the sideline cursor. During the catch up process, a third stream event occurring after the second stream event in the data stream may be obtained. Any suitable stream event discussed at 460, 462, 466, 468, and 472 may be an example of the third stream event.

At 610, the unrestricted replication for the partition may resume based at least in part on concluding the catch up process. By way of example, the device executing the operations of method 600 may perform the operations discussed in connection with 474 of FIG. 4. In some embodiments, these operations may include deleting the sideline cursor (e.g., the entry corresponding to the p4 partition stored within the sideline bucket 504 of FIG. 5.

### Example Infrastructure as a Service Architectures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

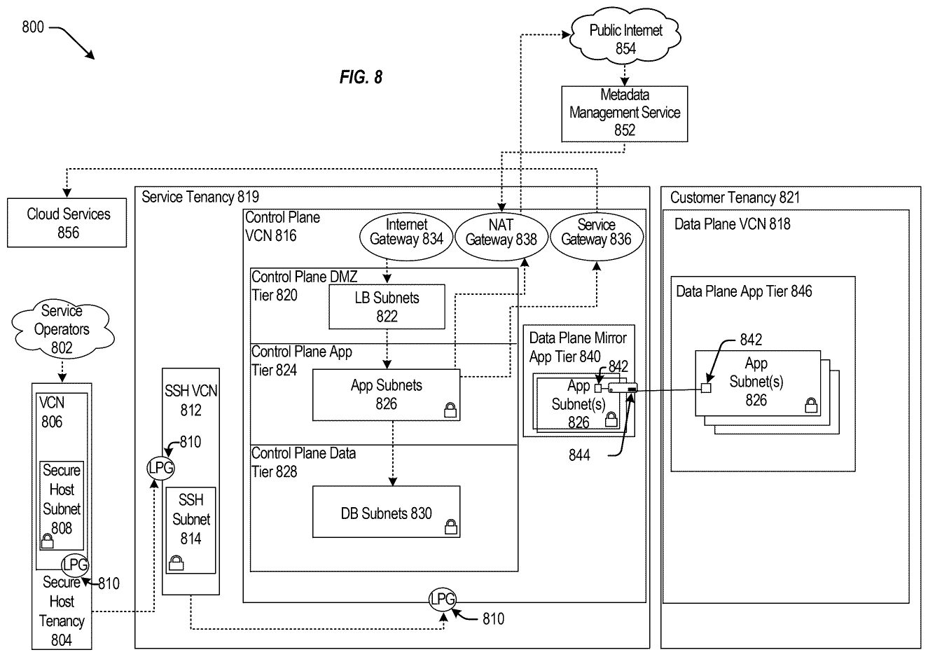

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 710 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively coupled to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 7,” may be located in Region 1 and in “Region 2.” If a call to Deployment 7 is made by the service gateway 836 contained in the control plane VCN 816 located in Region 1, the call may be transmitted to Deployment 7 in Region 1. In this example, the control plane VCN 816, or Deployment 7 in Region 1, may not be communicatively coupled to, or otherwise in communication with, Deployment 7 in Region 2.

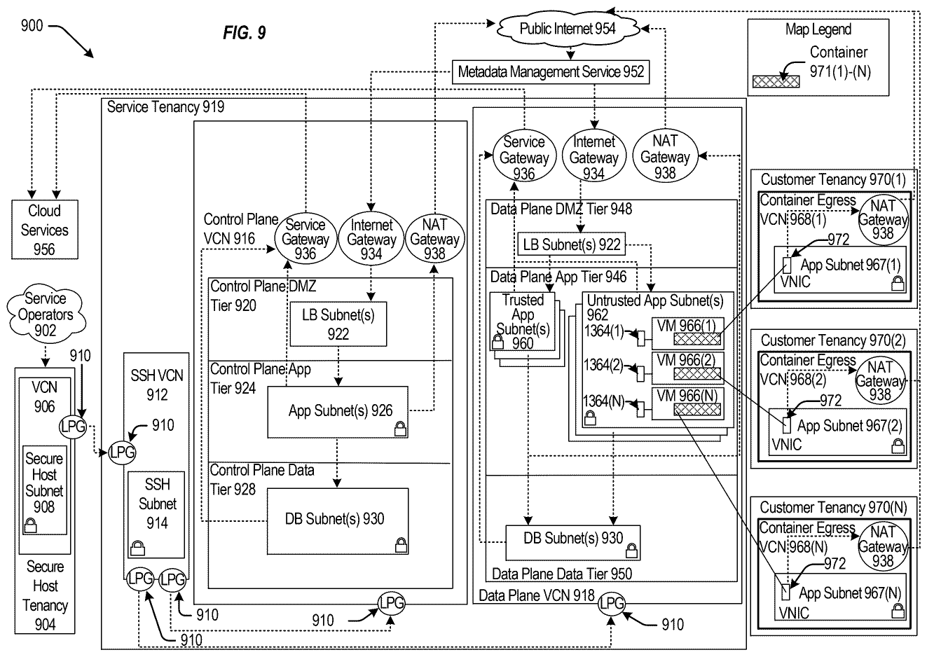

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

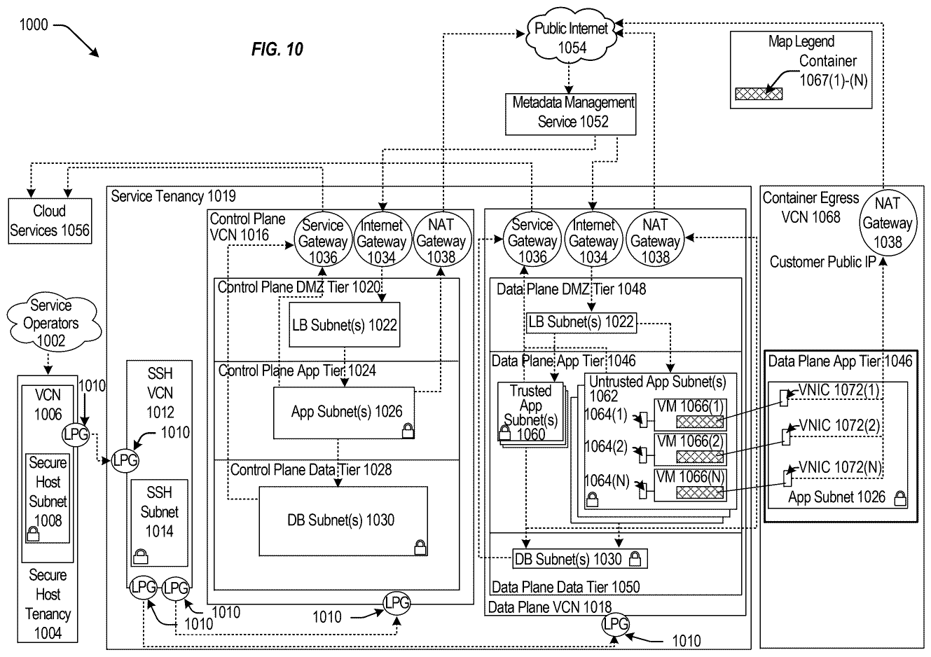

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N) and be communicatively coupled to an app subnet 1026 that can be contained in a data plane app tier 1046 that can be contained in a container egress VCN 1068.

Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (DSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
receiving, by a client device from a demuxer of a replication streaming system, a first stream event corresponding to a data stream that is associated with a plurality of partitions, the first stream event identifying a partition of the plurality of partitions and a streaming cursor, the client device tracking unrestricted replication for the partition using the streaming cursor;
in response to detecting an error corresponding to the first stream event, restricting, by the client device, replication of the partition based on generating a sideline cursor from the streaming cursor;
executing, by the client device using the sideline cursor, a bootstrap process during which a second stream event for the partition is obtained from a snapshot of the data stream;
executing, by the client device using the sideline cursor, a catch up process during which a third stream event occurring after the second stream event in the data stream is obtained; and
resuming, by the client device, the unrestricted replication for the partition based at least in part on concluding the catch up process.

2. The method of claim 1, wherein the first stream event and the third stream event are obtained from the demuxer, and wherein the second stream event is obtained from a data snapshot service instance of the replication streaming system.

3. The method of claim 2, wherein the recent snapshot service instance generates the snapshot of the data stream, wherein the second stream event is obtained from the snapshot of the data stream and transmitted based at least in part on receiving a bootstrap request message, the bootstrap request message being transmitted by the client device as part of the bootstrap process.

4. The method of claim 1, wherein the catch up process is executed based at least in part on determining that the bootstrap process has concluded.

5. The method of claim 1, wherein the client device stores respective values of the streaming cursor based at least in part on successfully processing respective stream events received from the demuxer.

6. The method of claim 1, wherein the demuxer receives stream events comprising the stream event from a streaming platform and distributes the stream events according to the plurality of partitions, and wherein the streaming platform distributes the stream events according to a second plurality of partitions that differ from the plurality of partitions used by the demuxer.

7. The method of claim 1, wherein determining that the catch up process has concluded comprises receiving a catch up message that indicates the catch up process has concluded.

8. A client device, comprising:
one or more processors; and
one or more memories storing computer-executable instructions that, when executed by the one or more processors, causes the one or more processors to:
incrementally process stream events of a data stream that is associated with a plurality of partitions, a most-recently received stream event identifying a partition of the plurality of partitions and a first cursor that represents a position in the data stream corresponding to the most-recently received stream event;
in response to detecting an error corresponding to the most-recently received stream event, restrict replication at the partition;
obtain, using a second cursor that indicates the position in the data stream corresponding to the most-recently received stream event, a first set of stream events for the partition, the first set of stream events being obtained from a snapshot of the data stream;
obtain a second set of stream events for the partition, the second set of stream events occurring after the first set of stream events in the data stream; and
resume unrestricted replication of the partition based at least in part on obtaining the first set of stream events and the second set of stream events.

9. The client device of claim 8, wherein executing the computer-executable instructions further cause the one or more processors to process a subsequent stream event corresponding to a second partition of the plurality of partitions, the subsequent stream event corresponding to the second partition being processed while the replication for the partition is being restricted.

10. The client device of claim 8, wherein executing the computer-executable instructions further cause the one or more processors to:
incrementally process respective stream events of the first set of stream events and the second set of stream events; and
update the second cursor as the respective stream events of the first set of stream events and the second set of stream events are incrementally processed, wherein the second cursor indicates progress of processing the first set of stream events and the second set of stream events.

11. The client device of claim 8, wherein executing the computer-executable instructions that obtain the first set of stream events for the partition, further causes the one or more processors to transmit, to a data snapshot service, a bootstrap request comprising a first value of the second cursor.

12. The client device of claim 11, wherein executing the computer-executable instructions that obtain the second set of stream events for the partition, further causes the one or more processors to transmit, to a demuxer, a catch up request comprising a second value of the second cursor.

13. The client device of claim 12, wherein the second value of the second cursor is identified based at least in part incrementally updating the second cursor as the first set of stream events are processed, the second value of the second cursor corresponding to a corresponding position within the data stream that is associated with a last stream event processed of the first set of stream events.

14. The client device of claim 12, wherein executing the computer-executable instructions further causes the one or more processors to receive a catch up end message that indicates a current value maintained by the demuxer for the first cursor, wherein the unrestricted replication of the partition is resumed using the current value for the first cursor.

15. A non-transitory computer-readable medium comprising one or more memories storing computer-executable instructions that, when executed by one or more processors of a client device, cause the one or more processors to:
incrementally process stream events of a data stream that is associated with a plurality of partitions;
track processing of the stream events based at least in part on maintaining a first set of cursors that individually indicate a last stream event that was successfully processed for a respective partition;
while continuing to process stream events for the data stream that correspond to at least one partition of the plurality of partitions, restrict stream event processing for a second partition of the plurality of partitions based at least in part on detecting an error associated with a stream event associated with the second partition;
responsive to determining that the stream event processing for the second partition is to resume, obtain a set of stream events for the second partition, the set of stream events occurring in the data stream after the stream event associated with the error;
track, using a second cursor that is separate from the first set of cursors, processing of the set of stream events for the second partition; and
resume unrestricted replication of the partition based at least in part on tracking the processing of the set of stream events for the second partition using the second cursor.

16. The non-transitory computer-readable medium of claim 15, wherein executing the computer-executable instructions that resume the unrestricted replication cause the one or more processors to receive, from a demuxer, a message that indicates that replication of the second partition is caught up to a current position of the data stream, wherein the unrestricted replication of the second partition is resumed based at least in part on deleting the second cursor.

17. The non-transitory computer-readable medium of claim 15, wherein the set of stream events comprises a first stream event obtained from a snapshot generated by a data snapshot service, and a second stream event obtained from a demuxer.

18. The non-transitory computer-readable medium of claim 17, wherein the first stream event is obtained from the snapshot during execution of a bootstrap process, wherein the second stream event is obtained during execution of a catch up process, and wherein the second cursor is used to track progress of the bootstrap process and the catch up process.

19. The non-transitory computer-readable medium of claim 15, wherein at least one cursor of the first set of cursors is updated based at least in part on processing a second data stream corresponding to a third partition of the plurality of partitions, wherein the third partition is different from the second partition, and wherein the at least one cursor indicates a subsequent position in the data stream that occurs after a position associated with the stream event that is associated with the second partition and for which the error was detected.

20. The non-transitory computer-readable medium of claim 15, wherein the first set of cursors is updated based at least in part on stream event processing of unrestricted partitions of the plurality of partitions.
